(19) United States
(12) Patent Application Publication
(10) Pub. No.: US 2003/0125948 A1
(43) Pub. Date: Jul. 3, 2003

(54) System and method for speech recognition by multi-pass recognition using context specific grammars

(76) Inventor: Yevgeniy Lyudovyk, Woodbridge, NJ (US)

Correspondence Address: KENYON & KENYON, 1500 K STREET, N.W., SUITE 700, WASHINGTON, DC, 20005, US

(21) Appl. No.: 10/334,897

(22) Filed: Jan. 2, 2003

Related U.S. Application Data
(60) Provisional application No. 60/343,591, filed on Jan. 2, 2002.
(60) Provisional application No. 60/343,588, filed on Jan. 2, 2002.
(60) Provisional application No. 60/343,590, filed on Jan. 2, 2002.
(60) Provisional application No. 60/343,595, filed on Jan. 2, 2002.
(60) Provisional application No. 60/343,596, filed on Jan. 2, 2002.
(60) Provisional application No. 60/343,593, filed on Jan. 2, 2002.
(60) Provisional application No. 60/343,592, filed on Jan. 2, 2002.
(60) Provisional application No. 60/343,589, filed on Jan. 2, 2002.
(60) Provisional application No. 60/343,597, filed on Jan. 2, 2002.

(51) Int. Cl. G10L 15/18

(52) U.S. Cl. 704/257

(57) ABSTRACT

Embodiments of the present invention relate to a system, method and apparatus for automatically recognizing and/or processing an input such as a user's communication. A user's communication may be received at a first speech recognizer and a recognized result of the user's communication may be generated. An informational database may be searched to find a list of matching entries that match the recognized result. A context specific grammar may be generated based on the list of matching entries. A refined recognized result of the user's communication may be generated based on the context specific grammar.

### CROSS REFERENCE TO RELATED PATENT APPLICATIONS

This patent application claims the benefit of, and incorporates by reference, each of: U.S. Provisional Patent Application Serial No. 60/343,591, U.S. Provisional Patent Application Serial No. 60/343,588, U.S. Provisional Patent Application Serial No. 60/343,590, U.S. Provisional Patent Application Serial No. 60/343,595, U.S. Provisional Patent Application Serial No. 60/343,596; U.S. Provisional Patent Application Serial No. 60/343,593, U.S. Provisional Patent Application Serial No. 60/343,592, U.S. Provisional Patent Application Serial No. 60/343,589, and U.S. Provisional Patent Application Serial No. 60/343,597, all filed Jan. 2, 2002.

### TECHNICAL FIELD

The present invention relates to automated attendants. In particular, the present invention relates to information recognition using a multi-pass recognition technique using context specific grammars.

### BACKGROUND OF THE INVENTION

In recent years, automated attendants have become very popular. Many individuals or organizations use automated attendants to automatically provide information to callers and/or to route incoming calls. An example of an automated attendant is an automated directory assistant that automatically provides a telephone number, address, etc. for a business or an individual in response to a user's request.

Typically, a user places a call and reaches an automated directory assistant (e.g. an Interactive Voice Recognition (IVR) system) that prompts the user for desired information and searches an informational database (e.g., a white pages listings database) for the requested information. The user enters the request, for example, a name of a business or individual via a keyboard, keypad or spoken inputs. The automated attendant searches for a match in the informational database based on the user's input and may output a voice synthesized result if a match can be found.

In cases where a very large information database such as the white pages listings database is used, developers may use statistical grammars of various kinds to efficiently recognize a user's communication and find an accurate result for a request by the user. Unfortunately, practical system limitations and/or requirements may limit the type and/or kind to grammars that can be applied to the particular system. For example, use of the grammars that could assure the best recognition accuracy may not be possible because the grammars may contain too many states that can result in the grammar compilation taking too much time, compiled grammars are too large to manage, grammar compilers cannot compile the grammar at all, recognition is too slow, or other such difficulties. Therefore developers may need to use such statistical grammars that may be smaller in size, but that may reduce the accuracy of the system. However, without such techniques processing a user's communication using large databases can be inefficient and impractical.

Take, for example, a listings database including entries, such as, all business listings in a big city. Every entry in the listing is a sequence of words that can be uttered or input by a user in many ways. For example, a user may omit some words, substitute some words and/or add other words. All these transformations to a particular listing and all word dependencies for this listing can be represented by a language model and a grammar specially designed for this listing. As is known, a grammar may be a formal representation of a language model in some formal language.

Using a sum of all listing-specific grammars for speech recognition would be the best way to proceed because a recognizer's recognition performance would be the best. Unfortunately although any one listing-specific grammar is not large, the combination of tens of thousands of such grammars presents a problem for grammar compilation utilities that very often crash because of the grammar size and complexity. Moreover even if such combined grammar is successfully compiled the recognition process may become inefficient and/or time consuming because the recognizer may have to search a plurality of parallel branches.

Statistical N-gram grammars are used to solve this problem. Using statistical N-gram grammars, the probability of each word to be input or uttered may be conditioned by the context, that is, by (N−1) preceding words. In this way, word combinations common to many listings are represented only once. This results in significant reduction of grammar size.

A grammar using N-grams where N=3 (called tri-grams) show almost the same performance as listing-specific based grammars. Grammars using N-grams for N=2 (called bi-grams) perform somewhat worse than tri-grams. Grammars where N=1 (called uni-grams) perform significantly worse than bi-grams.

Unfortunately, tri-gram grammars usually are too large for listing sets exceeding, for example, 50,000. Even bi-gram grammars may be too large for listing sets exceeding 300,000 listings, while uni-gram grammars may not be as large, even for listing sets exceeding millions of listings, but may suffer in performance and/or accuracy.

### SUMMARY OF THE INVENTION

Embodiments of the present invention relate to a system, method and apparatus for automatically recognizing and/or processing an input such as a user's communication. A user's communication may be received at a first speech recognizer and a recognized result of the user's communication may be generated. An informational database may be searched to find a list of matching entries that match the recognized result. A context specific grammar may be generated based on the list of matching entries. A refined recognized result of the user's communication may be generated based on the context specific grammar.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of an automated communication processing system in accordance with an embodiment of the present invention; and

FIG. 2 is a flowchart showing a method in accordance with an embodiment of the present invention.

### DETAILED DESCRIPTION

Embodiments of the present invention relate to a system, method and apparatus for automatically recognizing and/or processing a user's communication. Embodiments of the present invention provide a multi-pass technique to create a context specific grammar that may improve the accuracy of automatic attendants.

In embodiments of the present invention, a user's communication may be recognized and matched with entries in an information database, during a first pass. The matched entries may be used to generate a context specific grammar. During a second pass, the context specific grammar may be used to recognize the user's communication.

In embodiments of the present invention, the newly recognized communication may be may be output and/or may be used for further processing. In one example, the newly recognized communication may be matched with entries in the information database. The matched entry or entries may be output to a user, or the matched entries may be used to generate another context-specific grammar or to update the previous one. The new or updated grammar may be used to recognize the user's communication, during a third or subsequent pass.

In embodiments of the present invention, any number of passes may be taken to generate new and/or updated context specific grammars, and these context specific grammars may be used to recognize a user's communication. Embodiments of the present invention may provide a more efficient and/or effective system for automatically processing the user's request.

In embodiments of the invention, results of the multi-pass recognition system may be used to improve the accuracy and/or efficiency of the system.

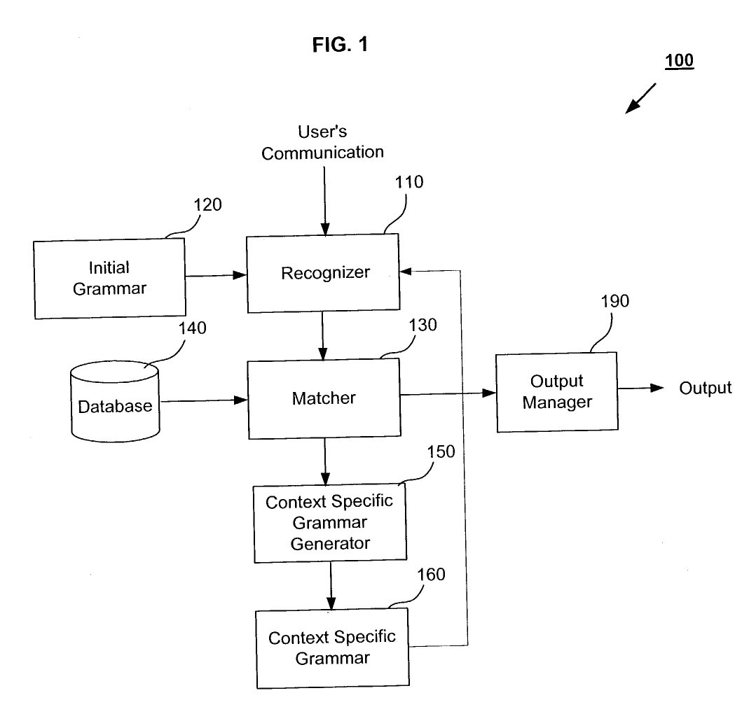

FIG. 1 is an exemplary block diagram of an automated communication processing system 100 for processing a user's communication in accordance with an embodiment of the present invention. A recognizer 110 is coupled to an initial grammar 120 and a matcher 130 that is coupled to a database 140. The matcher may be coupled to context specific grammar generator 150 that produces context specific grammar 160. The context specific grammar 160 may be coupled to recognizer 110 or another recognizer (not shown).

In embodiments of the present invention, the user's input may be speech input that may be input from a microphone, a wired or wireless telephone, other wireless device, a speech wave file or other speech input device.

While the examples discussed in the embodiments of the patent concern recognition of speech, the recognizer 110 may also receive a user's communication or inputs in the form of speech, text, digital signals, analog signals and/or any other forms of communications or communications signals and/or combinations thereof.

As used herein, user's communication can be a user's input in any form that represents, for example, a single word, multiple words, a single syllable, multiple syllables, a single phoneme and/or multiple phonemes. The user's communication may include a request for information, products, services and/or any other suitable requests.

A user's communication may be input via a communication device such as a wired or wireless phone, a pager, a personal digital assistant, a personal computer, and/or any other device capable of sending and/or receiving communications. In embodiments of the present invention, the user's communication could be a search request to search the World Wide Web (WWW), a Local Area Network (LAN), and/or any other private or public network for the desired information.

In embodiments of the present invention, the recognizer 110 may be any type of recognizer known to those skilled in the art. In one embodiment, the recognizer may be an automated speech recognizer (ASR) such as the type developed by Nuance Communications. The communication processing system 100, where the recognizer 110 is an ASR, may operate similar to an IVR but includes the advantages of the context specific grammar generator 150 and context specific grammar 160 in accordance with embodiments of the present invention.

In alternative embodiments of the present invention, the recognizer 110 can be a text recognizer, optical character recognizer and/or another type of recognizer or device that recognizes and/or processes a user's inputs, and/or a device that receives a user's input, for example, a keyboard or a keypad. In embodiments of the present invention, the recognizer 110 may be incorporated within a personal computer, a telephone switch or telephone interface, and/or an Internet, Intranet and/or other type of server.

In an alternative embodiment of the present invention, the recognizer 110 may include and/or may operate in conjunction with, for example, an Internet search engine that receives text, speech, etc. from an Internet user. In this case, the recognizer 110 may receive user's communication via an Internet connection and operate in accordance with embodiments of the invention as described herein.

In one embodiment of the present invention, the recognizer 110 receives the user's communication and generates a recognized result that may include a list of recognized entries, using known methods. The recognition of the user's input may be carried out using the initial grammar 120. The initial grammar 120 may be a large loose grammar that may be used by recognizer 110 while recognizing a user's communication. The initial grammar may be an N-grammar, a statistical grammar, and/or any other type of grammar suitable for the speech recognizer.

As an example, the initial grammar 120 may be a statistical N-gram grammar such as a uni-gram grammar, bi-gram grammar, tri-gram grammar, etc. The initial grammar 120 may be word-based grammar, subword-based grammar, phoneme-based grammar, or grammar based on other types of symbol strings and/or any combination thereof.

In embodiments of the preset invention, the list of recognized entries may include the N-best entries, where N may be may be a pre-defined integer such as 1, 2, 3 . . . 100, etc. Alternatively, each entry in the list of recognized entries generated by the recognizer 110 may be ranked with an associated first confidence score. The confidence score may indicate the level of confidence (or likelihood) that the hypothesis that this recognized entry contains the informational content (words, sub-words, phonemes, etc.) of the utterance that was uttered (or input) by the user. A higher first confidence score associated with a recognized entry may indicate a higher likelihood of the hypothesis that this recognized entry is what was uttered (or input) by the user.

In embodiments of the present invention, the first confidence score may be used to limit the entries in the list of recognized entries to N-best entries based on a recognition confidence threshold (e.g., THR1). For example, the recognizer 110 may be set with a minimum recognition confidence threshold. Entries having a corresponding first confidence score equal to and/or above the minimum recognition confidence threshold may be included in the list of recognized N-best entries.

In embodiments of the present invention, entries having a corresponding first confidence score less than the minimum recognition threshold may be omitted from the list. The recognizer 110 may generate the first confidence score, represented by any appropriate number, as the user's communication is being recognized. The recognition threshold may be any appropriate number that is set automatically or manually, and/or may be adjustable, based on, for example, on the top-best confidence scores. It is recognized that other techniques may be used to select the N-best results or entries.

In embodiments of the present invention, the entries in the list of recognized entries may be a sequence of words, sub-words, phonemes, or other types of symbol strings and/or combination thereof.

In embodiments of the present invention, each entry in the list of recognized entries may be text or character strings that represent individual or business listings and/or other information for which the user is requesting additional information. In one example, a recognized entry may be the name of a business for which the user desires a telephone number. Each entry included in the list of recognized entries generated by the recognizer 110 may be a hypothesis of what was originally input by the user.

In embodiments of the present invention, the recognized entries may be presented, for example, by a graph that contains paths that represent possible sequence of elements like words, sub-words, phonemes, etc. with computable confidence scores. The graph may be included in addition to and/or instead of the N-best recognized entries generated by the recognizer.

In embodiments of the present invention, the list of recognized entries generated by the recognizer 110 may be input to matcher 130. The matcher 130 may receive the recognized results with corresponding first confidence scores and may search database 140. The matcher 130 may search database 140 and generate a list of one or more entries that match the entries in the recognized results (e.g., the list of recognized entries). The list of matching entries may represent, for example, what the caller had in mind when the caller inputs the communication into recognizer 110.

The matching algorithm employed by matcher 130 may be based on words, sub-word, phonemes, characters or other types of symbol strings and/or any combination thereof. For example, matcher 130 can be based on N-grams of words, characters or phonemes.

In embodiments of the present invention, the list of matching entries generated by the matcher 130 may be a list of M-best matching entries, where M may be may be a pre-defined integer such as 1, 2, 3 . . . 100, etc. It is recognized that each entry in the list of matching entries generated by the matcher 130 may be ranked with an associated second confidence score. The second confidence score may indicate the level of confidence (or likelihood) that a particular matching entry is the entry in database 140 that the user had in mind when she uttered the utterance. A higher second confidence score associated with a matching entry may indicate a higher level of likelihood that this particular matching entry is the entry that the user had in mind when she uttered the utterance.

In embodiments of the present invention, the second confidence score may be used to limit the entries in the list of matching entries to M-best entries based on a matching confidence threshold (e.g., THR2). For example, the matcher 130 may be set with a minimum matching confidence threshold. Entries having a corresponding second confidence score equal to and/or above the minimum matching threshold may be included in the list of matching M-best entries.

In embodiments of the present invention, entries having a corresponding second confidence score less than the minimum matching threshold may be omitted from the list. The matcher 130 may generate the confidence score, represented by any appropriate number, as the database 140 is being searched for a match. The matching threshold may be any appropriate number that is set automatically or manually, and/or may be adjustable, based on, for example, on the top-best confidence scores. It is recognized that other techniques may be used to select the M-best entries.

In embodiments of the present invention, the database 140 may include an informational database such as a listings database that has stored information entries that represent information relating to a particular subject matter. For example, the listings database may include residential, governmental, and/or business listings for a particular town, city, state, and/or country.

It is recognized that the stored entries in database 140 could represent or include a myriad of other types of information such as individual directory information, specific business or vendor information, postal addresses, e-mail addresses, etc. In embodiments of the present invention, the database 140 can be part of larger database of listings information such as a database or other information resource that may be searched by, for example, any Internet search engine when performing a user's search request.

In an exemplary embodiment of the present invention, the matcher 130 may, for example, extract one or more recognized N-grams from each entry in list of recognized entry generated by the recognizer 110. Based on these recognized N-grams, the matcher 130 may search all of the entries in the database 140 and generate a list of M-best matching entries including a corresponding second confidence score for each matched entry in the list. It is recognized that in embodiments of the present invention, the entire database 140 may be searched and/or only a portion of the database may be searched for matching entries.

It is recognized that, if the corresponding confidence scores are sufficient, the N-best recognized entries and/or the matching M-best entries may be output to a user and/or output by the matcher or recognizer for further processing. In this case, the first pass may be sufficient to complete the request.

In accordance with embodiments of the present invention, the list of M-best entries may be input to a context specific grammar generator 150. The context specific grammar generator 150 may generate a context specific grammar 160 using either only the list of M-best matched entries generated by matcher 130, and/or it may additionally use the whole informational database 140 or a portion of the database 140 to generate and/or update the context specific grammar 160.

In embodiments of the invention, more weight may be given to the entries from the list of M-best matching entries than the entries in the informational database that are not in the M-best list. The entries included in grammar 160, generated by the context specific grammar generator 150, may be N-gram grammars, combination of listing-specific grammars or other types of grammars and/or any combination thereof. If the context specific-grammar 160 is an N-gram grammar, N may be greater for the context specific grammar 160 than the N for the initial grammar 120, if the initial grammar 120 is an N-gram grammar.

In embodiments of the present invention, the entries included in context specific grammar 160 may be more context specific (or listing specific) or tighter since the grammar was generated by the generator 150 using, for example, matching M-best entries (or giving them more weight) that may be in the context of and/or related to the information input and/or requested by the user.

In embodiments of the present invention, context specific grammars may be based on and/or defined by the user's input. For example, the user's communication and/or request as best recognized and/or initially matched may be used to generate the context specific grammars. The entire communication, or recognized or matched entry or entries, or any portion and/or combination thereof may be used to generate the context-specific grammar.

It is recognized that when a database search is conducted, in accordance with embodiments of the present invention, the entire database or a portion of the database may be searched. The database may be searched based on the context of the user's communication. In some cases the user's best recognized communication may define the context of the request and may be used to determine the portion of the database to be searched based on this context. For example, if the user's communication is best recognized or hypothesized to be “Tony's Restaurant,” then the context of the search may be defined as “restaurant.” Accordingly, in embodiments of the present invention, the search may be focused on listings that either have the word “restaurant” and/or in that category. It is recognized that other listings that may not be in the context of the request may also be searched, but less weight may be given to those listings, for example.

It is recognized that there may be any number of ways that may be used to determine the context, in embodiments of the present invention. For example, the N-gram characters contained in the recognized entries may be used to determine context.

In embodiments of the present invention, recognizer 110 may be run a second time (e.g., a second pass) to recognize the user's communication. However, this time, the user's communication may be recognized using the context specific grammar 160, generated by the context specific grammar generator. In this case, the recognizer 110 may takes the user's communication as the input and may output a list of new recognized entries or a refined recognized result.

In embodiments of the present invention, it is recognized that the second pass or subsequent passes may be run through the same recognizer (e.g., recognizer 110) or a different recognizer (not shown). For example, the list of new recognized entries (e.g., N-best) may be recognized using a different recognizer (not shown). If a different recognizer is used, it may be of a different manufacturer or the same manufacturer as recognizer 110.

In embodiments of the present invention, the recognizer used for the second or subsequent passes may be set using different control parameters, sensitivity levels, thresholds, confidence scores, etc. For example, the value of N for the N-best recognition results may be 20, while the value of N for the new N-best recognition results may be 3 or another value. In either case, the recognizer may use the context specific grammar 160 to generate the list of new recognized entries. Other parameters such as the recognition speed and/or the accuracy of recognizer may be varied.

In embodiments of the preset invention, the list of new recognized entries may include new N-best entries, where N may be may be a pre-defined integer such as 1, 2, 3 . . . 100, etc. Alternatively, each entry in the list of recognized new entries generated by the recognizer 110 may be ranked with an associated third confidence score. As before, the third confidence score may indicate the level of confidence or likelihood of the hypothesis that this new recognized entry produced using the context specific grammar 160 is what was uttered (or input) by the user. A higher third confidence score associated with a new recognized entry may indicate a higher likelihood of the hypothesis that this recognized entry is what was uttered (input) by the user.

In embodiments of the present invention, the third confidence score may be used to limit the entries in the new list of recognized entries to a new set of N-best entries based on a context specific recognition confidence threshold (e.g., THR3). This recognition threshold may be the same as or different from the other thresholds described above. For example, the recognizer 110 may be set with a minimum context specific recognition threshold. Entries having a corresponding third confidence score equal to and/or above the minimum context specific recognition threshold may be included in the list of recognized new N-best entries.

In embodiments of the present invention, entries having a corresponding third confidence score less than the minimum context specific recognition threshold may be omitted from the list of new recognized entries. The recognizer 110 may generate the third confidence score, represented by any appropriate number, as the user's communication is being recognized during a second or context specific grammar. The context specific recognition threshold may be any appropriate number that is set automatically or manually, and/or may be adjustable, based on, for example, on the top best confidence scores. It is recognized the other techniques may be used to select the new N-best recognized entries or the list of new N-best recognized entries.

In embodiments of the present invention, the entries in the list of new recognized entries may be a sequence of words, sub-words, phonemes, or other types of symbol strings and/or combination thereof.

In embodiments of the system 100, the list of new N-best recognized entries may be output by the system and may be used as needed by the encompassing system such as to improve the accuracy and/or efficiency of the system 100.

In alternative embodiments of the present invention, the list of new N-best recognized entries with or without the third confidence scores may be input to matcher 130. The matcher may search database 140 to generate a list of one or more new matching entries that match the entries of the list of recognized new N-best entries. As described above, the matcher may search either a portion or the entire database. The matcher may give more weight to certain entries in the database based on the context of the user's communication.

In embodiments of the present invention, the list of new matching entries generated by the matcher 130 may be a list of new M-best matching entries, where M may be may be a pre-defined integer such as 1, 2, 3 . . . 100, etc. Alternatively, each entry in the list of new matching entries generated by the matcher 130, during this second pass, may be ranked with an associated fourth confidence score. The fourth confidence score may indicate the level of confidence (or likelihood) that a particular matching entry is the entry in database 140 that the user had in mind when she uttered the utterance. A fourth second confidence score associated with a matching entry may indicate a higher level of likelihood that this particular matching entry is the entry that the user had in mind when she uttered the utterance.

In embodiments of the present invention, the fourth confidence score may be used to limit the entries in the list of new matching entries to M-best entries based on a context specific matching confidence threshold (e.g., THR4). For example, the matcher 130 may be set with a minimum context specific matching threshold. Entries having a corresponding fourth confidence score equal to and/or above the minimum context specific matching threshold may be included in the list of matching new M-best entries.

In embodiments of the present invention, entries having a corresponding fourth confidence score less than the minimum context specific matching threshold may be omitted from the new list. The matcher 130 may generate the fourth confidence score, represented by any appropriate number, as the database 140 is being searched for a match, during a second or next pass. The context specific matching threshold may be any appropriate number that is set automatically or manually, and may be adjustable, based on for example, the top-best confidence scores. It is recognized that other techniques may be used to select the new M-best results.

It is recognized that, in embodiments of the present invention, the list of matching new M-best entries, for example, generated using the list of recognized new N-best entries, may be generated using the matcher 130 or a different or second matcher (not shown). If a different matcher is used, it may be of a different manufacturer or the same manufacturer and/or may employ different or same matching algorithms as matcher 130. The matcher used for the second pass or subsequent passes may be set using different control parameters, sensitivity levels, thresholds, confidence scores, etc. For example, the value of M for the M-best matching entries may be 15, while the value of M for the new M-best matching entries may be 3 or another value.

In embodiments of the present invention, the list of new M-best matching entries may be closer to what the caller had in mind when the caller inputs the communication into recognizer 110.

In an embodiment of the present invention, the list of new M-best matching entries may be output to a user for presentation and/or confirmation via output manager 190.

In embodiments of the present invention, the matcher 130 may output to the output manager 190 for further processing. For example, depending on the distribution of the fourth confidence score associated with each entry in the list of new N-best entries and/or some other parameter, the output manager 190 may automatically route a call and/or present requested information to the user without user intervention.

Depending on the same distributions and/or parameters, the output manager 190 may forward the list of new M-best matching entries to the user for selection of the desired entry. Based on the user's selection, the output manager 190 may route a call for the user, retrieve and present the requested information, or perform any other function.

In embodiments of the present invention, depending on the same distributions, the output manager 190 may present another prompt to the user, terminate the session if the desired results have been achieved, or perform other steps to output a desired result for the user. If the output manager 190 presents another prompt to the user, for example, asks the user to input the desired listings name once more, another list of new M-best matching entries may be generated and may be used to help the output manager 190 to make the final decision about the user's goal.

In alternative embodiments of the present invention, another pass such as a third pass may be initiated to create another or updated context specific grammar that may be used by the recognizer and/or matcher to generate another list of matching entries. For example, the list of new M-best matching entries may be forwarded by the matcher 130 to the context specific grammar generator 150.

The grammar generator 150 may generate a new grammar 160 and/or may update the previously generated grammar 160 based on the list of new Mbest matching entries. This new or updated grammar may be used by the recognizer to generate another list of N-best recognized entries based on the user's communication. The result may be sent to the matcher which may generate another recognized list of M-best entries. This new list may be sent to the output manager 190 for presentation to the user and/or further processing, as descried above, or may be used by the grammar generator 150 to generate a new grammar 160 and/or may update the previously generated grammar 160.

In embodiments of the present invention, any number of passes may be performed to generate an accurate representation of the user's communication and/or process the user's communications session. In one embodiment, the number of passes to be performed may be predetermined, while in another embodiment the number of passes may be defined dynamically based on recognition/matching results, confidence scores, etc. Accordingly, in some cases there may only be one (1) pass, while in other cases there may be two (2) or more passes performed by the system 100, in accordance with embodiments of the present invention.

In embodiments of the present invention, one or more new and/or updated grammars 160 generated for the second pass, for example, may be created before runtime (e.g., prior to receiving a user's communication). In this case, instead of finding m-best matching listings for n-best recognition results, the matcher 130, for example, may search the set of second pass grammar 160 best matching n-best recognition results.

Although, the description of the present invention references processing of inputs by a human, it is recognized that inputs by a machine or non-human may also be processed in accordance with embodiments of the present invention. Such machine or non-human inputs may be in any form such as computer-generated voice, electrical signals, digitized data, and/or any other form or any combination thereof.

It is recognized that the configuration and/or the functionality of the communication(s) processing system 100 and its various components (e.g., recognizer, matcher, context specific grammar generator, etc.) as shown in FIG. 1 and described above, is given by example only and modifications can be made to the communication(s) processing system 100 and/or its underlying components that fall within the spirit of the invention.

For example, in alternative embodiments of the invention, the matcher and/or context specific grammar generator, etc. and/or the functionality of these components may be incorporated into the recognizer, the output manager and/or any combination(s) may be formed. In yet further embodiments of the present invention, the intelligence of the communication(s) processing system 100 may be integrated into one or more application specific integrated circuits (ASICs) and/or one or more software programs.

It is recognized that the device incorporating the system 100 may include one or more processors, one or more memories, one or more ASICs, one or more displays, communication interfaces, and/or any other components as desired and/or needed to achieve embodiments of the invention described herein and/or the modifications that may be made by one skilled in the art. It is recognized that suitable software programs and/or hardware components/devices may be developed by a programmer and/or engineer skilled in the art to obtain the advantages and/or functionality of the present invention. Embodiments of the present invention can be employed in known and/or new Internet search engines, for example, to search the World Wide Web.

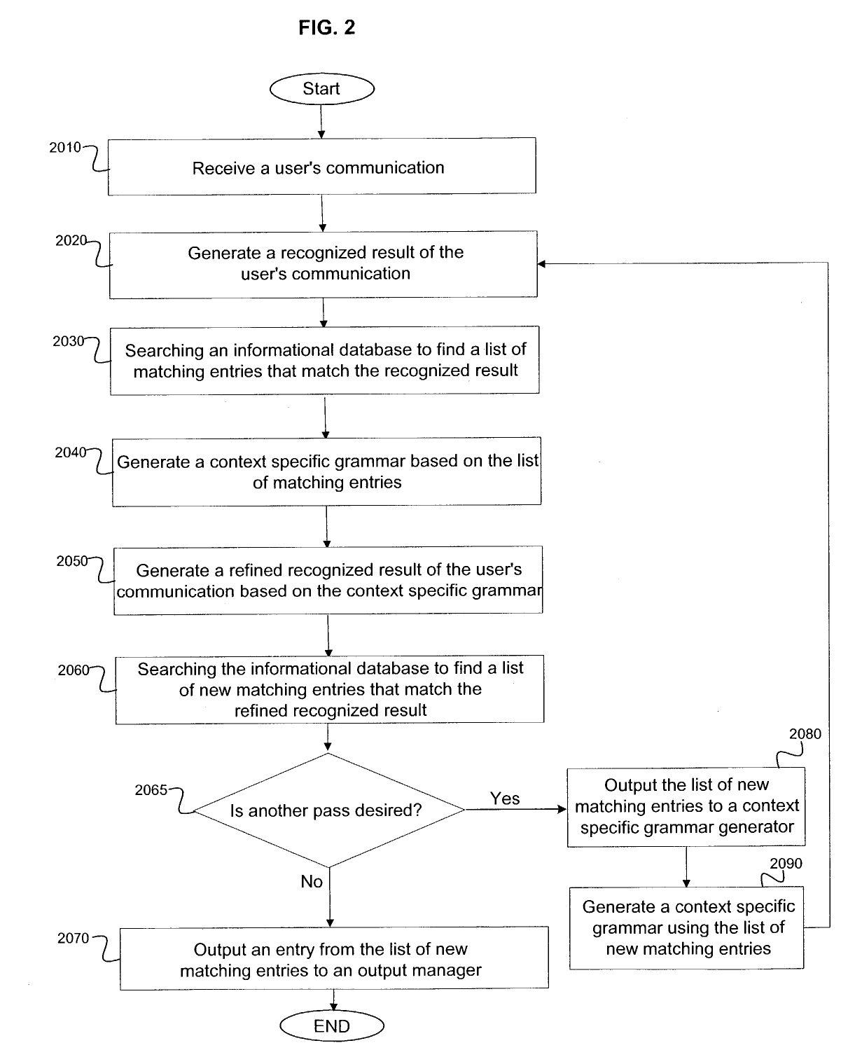

Referring now to FIG. 2, a method for automatically recognizing a user's communication in accordance with exemplary embodiments of the present invention will now be described. In this example, a user may call, for example, directory assistance to locate the telephone number, address and/or other information for a particular individual, organization, agency, business, etc. After the call is connected, an automated communication processing system 100, for example, may receive the call and request the user to enter a search criteria.

The communication processing system 100 may include an automated attendant, an IVR or other suitable automated attendant or answering service. The search criteria could be, for example, the name of a business for which additional information is required. The search criteria could be a user's communication that can be spoken inputs, inputs entered via a keypad or keyboard, or other suitable inputs.

For example, the user calls directory assistance for a large city that may have over 400,000 business listings. The directory assistance may employ a automated system such as system 100 that uses, for example, a bi-gram grammar for first pass recognition. The user may desire a telephone number for the business listing such as “pins meditation and diversion project.” The caller may input “meditation and diversion project” to the recognizer 110 of the system 100. The user's communication or input may be received by the recognizer 110, as shown in 2010. The recognizer 110 may generate a recognized result of the user's communication, as shown in 2020.

In this example, the recognizer may generate a recognized result that includes a list of N-best recognized entries where N, for example, is equal to three (3). The list may include the following entries along with a corresponding first confidence score (conf1) for each entry:

“television and public project”, conf1 52

“construction and diversion magazine”, conf1 49

“meditation and arc development”, conf1 45

In embodiments of the present invention, an informational database may be searched to find a list of matching entries that match the recognized result, as shown in 2030. The matcher 130 may search the database 140 for entries that match the recognized result and a list of matching entries based on found matches may be generated. It is recognized that the informational database 140 may be a listings database including business listings for a particular city.

In this example, the matcher 130 may search database 140 to find one or more matching entries for the N-best recognized entries. The search may produce a list of M-best matching entries, where M, for example, is equal to three (3). The list of M-best matching entries may include the following entries along with a corresponding second confidence score (conf2) for each entry:

“public construction and development project”, conf2 47

“pins meditation and diversion project”, conf2 45

“the press and the public project”, conf2 44

It is recognized that one or more entries from the M-best list (or N-best) having higher confidence scores may be presented to the user for selection and/or confirmation. In this example, the entry “public construction and development project having a corresponding second confidence score of 47 may be presented. Since this does not match the user's communication, the user may have to input the communication again and/or may ask for another entry. In either case, further processing may be needed.

It is recognized that if entries in the N-best recognized list and/or M-best matching list include sufficient confidence scores, then that or those entries may be presented to the user and/or used for further processing by the system.

However, in accordance with embodiments of the present invention, the system 100 may employ a second pass to obtain a more accurate matching result. A context specific grammar based on the list of matching entries may be generated, as shown in 2040. The context specific grammar generator 150 may take the list of M-best matched entries and may generate a context specific grammar 160. In this example, the context specific grammar generator 150 may generate a grammar 160 containing three context specific or listing-specific sub-grammars that could be presented as follows using notation used by, for example, Nuance Corporation of Menlo Park, Calif. These grammars may include:

.Gr1 (?public ?construction ?and ?development ?project)

.Gr2 (?pins ?meditation ?and ?diversion ?project)

.Gr3 (?the ?press ?and ?the ?public ?project)

In the above sub-grammar list, the question mark (?) in front of a word may mean that this word is optional and can be skipped by a user when she pronounces a listing name. It is recognized that other type of punctuation marks that designate other possibilities may be used. For example, ?construction˜0.8 means that the probability of word “construction” to be uttered is 0.8, and to be skipped is 0.2. Thus, for example, some of the word sequences that grammar .Gr2 would accept include:

“pins meditation and diversion project”

“meditation and diversion project”

“meditation and project”

It is recognized that a grammars .Gr1 and .Gr3, respectively, would also include a plurality of word sequences that each respective grammar would accept. However, these word sequences are not listed for convenience.

As shown in 2050, a refined recognized result of the user's communication based on the context specific grammar may be generated. In embodiments of the present invention, the context or listing specific grammar may be applied to the user's communication, by a recognizer, to produce a list of new recognized entries or a refined recognized result. The recognizer may be recognizer 110 or a different recognizer (not shown).

In this example, the recognizer may produce the following list of new recognized entries generated using the context specific grammar 160. The list of new N-best recognized entries may include the following entries along with a corresponding third confidence score (conf3) for each entry:

“meditation and diversion project”, conf3 64

“construction and development”, conf3 57

“the press and public project”, conf3 48

In embodiments of the present invention, the refined recognized result (e.g., the list of new N-best recognized entries) may be used to improve the accuracy of the automated system.

In alternative embodiments of the present invention, the refined recognized result may be output to a matcher. The informational database may be searched to find a list of new matching entries that match the refined recognized result, as shown in 2060. Thus, the list of new N-best recognized entries may be input to a matcher.

In embodiments of the present invention, the matcher may search the entire or a portion of the database 140 using the information in the list of new N-best recognized entries and may generate a new list of matching entries. It is recognized that the matcher may be matcher 130 or a different matcher (not shown).

In embodiments of the present invention, the matcher may generate the following list of new M-best entries along with a corresponding confidence score (conf4):

“meditation and diversion project”, conf4 63

“construction and development”, conf4 52

“the press and public project”, conf4 46

In embodiments of the present invention, the list of new M-best entries includes the M-best matching entries from the database 140 or a different database (not shown).

In embodiments of the present invention, if another pass is not desired, then an entry from the list of new matching entries may be output to an output manager, as shown in 2065 and 2070. For example, the matcher 130 may select the matched entry with the highest confidence score for output to the user via output manager 190. In this case, the final matched entry would be “meditation and diversion project” that has the highest confidence score of 64. Advantageously, this entry matches the user's communication. It is recognized that more than one entry may be output via output manager 190 and the user may select the desired entry.

In alternative embodiments of the present invention, if another pass (e.g., third pass or next pass) through the system 100 is desired, the list of new matching entries may be output to a context specific grammar generator, as shown in 2065 and 2080. As shown in 2090, a context specific grammar using the list of new matching entries may be generated and may be used by a recognizer to find another N-best recognized match for the user's communication, as shown in 2020. It is recognized that any number of passes may be taken through system 100 to generate an accurate recognized and/or matched entry for the user's communication in accordance with embodiments of the present invention.

In embodiments of the present invention, a context specific grammar may be generated using a multi-pass technique using automated communication processing system 100. The context specific grammar may be smaller and closer to the context of the user's input. In accordance with embodiments of the present invention, an initial pass through the system 100 may generate a context specific grammar. During a second or next pass, a recognizer and/or matcher may use the context specific grammar to generate a more accurate result that matches the user's communication. The result may be output to the user or additional passes may be taken through the system 100 to generate a more refined context-specific grammar that may be used by the recognizer and/or matcher to generate more accurate results, in accordance with embodiments of the present invention.

Embodiments of the present invention may enable, for example, speech recognition applications to make use of lower entropy of a total item set to be recognized versus higher entropy or perplexity of intermediate language models.

In embodiments of the present invention, a grammar of affordable complexity is created and compiled for a first recognition pass. Lowering the grammar complexity introduces some additional amount of uncertainty (entropy) that may make speech recognition process less accurate. At run-time, for example, a user's communication may be recognized by a recognizer producing a list of N-best recognition results. Based on the N-best list a matcher may find M-best matching items in the total item set (e.g., M-best matching listings in the set of all business listings of a big city). The total item list may have lower entropy (uncertainty) then the grammar used by recognizer.

The list of M-best matching entries may contains less uncertainty then the original list of N-best recognized entries. A new small and/or maximally constraining grammar may be created from the M-best matching entries. The recognizer may recognize the same communication against this new grammar. Accordingly, a more accurate list of N-best recognition results may be generated. In embodiments of the present invention, this new N-best list may be used to improve the accuracy of the system.

In accordance with embodiments of the present invention, this new N-best list can be used for finding new M-best matching items that may either be the final result or used for the next pass to generate of a new grammar, recognition of the same communications, generating new N-best recognition results, etc.

It is recognized that any suitable hardware, software, and/or any combination thereof may be used to implement the above-described embodiments of the present invention. The systems and/or apparatus shown in FIG. 1 and described in corresponding text, and the methods shown in FIG. 2 and described in corresponding text can be implemented using hardware and/or software that are well within the knowledge and skill of persons of ordinary skill in the art.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
receiving a user's communication at a first speech recognizer;
generating a recognized result of the user's communication by the first speech recognizer;
searching an informational database to find a list of matching entries that match the recognized result;
generating a context specific grammar based on the list of matching entries;
generating a refined recognized result of the user's communication based on the context specific grammar;
searching the informational database to find a list of new matching entries that match the refined recognized result; and
outputting the list of new matching entries.

2. The method of claim 1, further comprising:
generating the recognized result by the first speech recognizer based on the user's communication and an initial grammar.

3. The method of claim 2, wherein the recognized result of the first speech recognizer includes a list of N-best recognized entries.

4. The method of claim 3, wherein the list of N-best recognized entries includes one entry.

5. The method of claim 3, wherein the list of N-best recognized entries includes more than one entry.

6. The method of claim 2, wherein the initial grammar is a uni-gram grammar.

7. The method of claim 2, wherein the initial grammar is a bi-gram grammar.

8. The method of claim 2, wherein the initial grammar is a tri-gram grammar.

9. The method of claim 1, wherein the list of matching entries includes a list of M-best matching entries.

10. The method of claim 9, wherein the list of M-best matching entries includes one entry.

11. The method of claim 9, wherein the list of M-best matching entries includes more than one entry.

12. The method of claim 1, wherein the refined recognized result is generated by a second speech recognizer.

13. The method of claim 1, wherein the first information database is a listings database.

14. The method of claim 1, wherein the refined recognized result is generated by the first speech recognizer.

15. The method of claim 1, wherein the refined recognized result includes a list of new N-best recognized entries.

16. The method of claim 1, wherein the list of new matching entries includes a list of new M-best matching entries.

17. The method of claim 16, wherein outputting the list of new matching entries comprises:
outputting an entry from the list of new matching entries to a user.

18. The method of claim 16, further comprising:
outputting the list of new matching entries to an output manager.

19. The method of claim 1, wherein outputting the list of new matching entries comprises:
outputting the list of new matching entries to a context specific grammar generator.

20. The method of claim 1, further comprising:
generating a new context specific grammar based on the list of new matching entries.

21. The method of claim 20, further comprising:
generating a new refined recognized result of the user's communication based on the new context specific grammar.

22. The method of claim 21, further comprising:
searching the informational database for a list of refined matching entries that match the new refined recognized result.

23. The method of claim 22, further comprising:
outputting the list of refined matching entries.

24. The method of claim 23, outputting the list of refined matching entries further comprises:
outputting an entry from the list of refined matching entries to a user.

25. The method of claim 23, further comprising:
outputting the list of refined matching entries to the context specific grammar generator.

26. An apparatus comprising:
a speech recognizer that is to receive a user's communication and generate a recognized result of the user's communication;
a matcher that is to search an informational database to find a list of matching entries that match the recognized result; and
a context specific grammar generator that is to generate a context specific grammar based on the list of matching entries, wherein the speech recognizer is to generate a refined recognized result of the user's communication based on the context specific grammar.

27. The apparatus of claim 26, further comprising:
a second matcher that is to search the informational database to find a list of new matching entries that match the refined recognized result.

28. The apparatus of claim 26, further comprising:
an output manager that is to output the list of new matching entries to a user.

29. The apparatus of claim 26, wherein the matcher is to search the informational database to find a list of new matching entries that match the refined recognized result.

30. The apparatus of claim 26, further comprising:
an initial grammar, wherein the speech recognizer is to generate a recognized result for the user's communication based on the initial grammar.

31. An apparatus comprising:
a first speech recognizer that is to receive a user's communication and generate a recognized result of the user's communication;
a matcher that is to search an informational database to find a list of matching entries that match the recognized result;
a context specific grammar generator that is to generate a context specific grammar based on the list of matching entries; and
a second speech recognizer that is to generate a refined recognized result of the user's communication based on the context specific grammar.

32. The apparatus of claim 31, wherein the first speech recognizer and the second speech recognizer are the same speech recognizer.

33. The apparatus of claim 31, further comprising:
a second matcher that is to search the informational database to find a list of new matching entries that match the refined recognized result.

34. The apparatus of claim 31, further comprising:
an output manager that is to output the list of new matching entries to a user.

35. The apparatus of claim 31, wherein the matcher is to search the informational database to find a list of new matching entries that match the refined recognized result.

36. The apparatus of claim 30, further comprising:
an initial grammar, wherein the first speech recognizer is to generate a recognized result for the user's communication based on the initial grammar.

37. The apparatus of claim 36, wherein the initial grammar is a statistical grammar.

38. A method comprising:
receiving a user's communication at a first speech recognizer;
generating a recognized result of the user's communication by the first speech recognizer;
searching an informational database to find a list of matching entries that match the recognized result;
generating a context specific grammar based on the list of matching entries; and
generating a refined recognized result of the user's communication based on the context specific grammar.

39. The method of claim 38, further comprising:
searching the informational database to find a list of new matching entries that match the refined recognized result.

40. The method of claim 39, further comprising:
outputting the list of new matching entries.

41. The method of claim 40, wherein outputting the list of new matching entries comprises:
outputting the list of new matching entries to a context specific grammar generator.

42. The method of claim 41, further comprising:
generating a new context specific grammar based on the list of new matching entries.

43. The method of claim 42, further comprising:
generating a new refined recognized result of the user's communication based on the new context specific grammar.

44. The method of claim 39, wherein the list of new matching entries includes a list of new M-best matching entries.

45. The method of claim 38, further comprising:
generating the recognized result of the user's communication based on an initial grammar.

46. The method of claim 38, wherein the recognized result of the first speech recognizer includes a list of N-best recognized entries.

47. The method of claim 38, wherein the list of matching entries includes a list of M-best matching entries.

48. The method of claim 38, wherein the refined recognized result is generated by the first speech recognizer.

49. The method of claim 38, wherein the refined recognized result includes a list of new N-best recognized entries.

50. A machine-readable medium having stored thereon a plurality of executable instructions, the plurality of instructions comprising instructions to:
receive a user's communication at a first speech recognizer;
generate a recognized result of the user's communication by the first speech recognizer;
search an informational database to find a list of matching entries that match the recognized result;
generate a context specific grammar based on the list of matching entries; and
generate a refined recognized result of the user's communication based on the context specific grammar.

51. The machine-readable medium of claim 50 having stored thereon additional executable instructions, the additional instructions comprising instructions to:
search the informational database to find a list of new matching entries that match the refined recognized result.

52. The machine-readable medium of claim 51 having stored thereon additional executable instructions, the additional instructions comprising instructions to:
output the list of new matching entries.

53. The machine-readable medium of claim 52 having stored thereon additional executable instructions, the additional instructions comprising instructions to:
output the list of new matching entries to a context specific grammar generator.

54. The machine-readable medium of claim 53 having stored thereon additional executable instructions, the additional instructions comprising instructions to:
generate a new context specific grammar based on the list of new matching entries.

55. The machine-readable medium of claim 54 having stored thereon additional executable instructions, the additional instructions comprising instructions to:
generate a new refined recognized result of the user's communication based on the new context specific grammar.

56. The machine-readable medium of claim 50 having stored thereon additional executable instructions, the additional instructions comprising instructions to:
generate the recognized result of the user's communication based on an initial grammar.
